(19) United States
(12) Patent Application Publication
(10) Pub. No.: US 2022/0237067 A1
(43) Pub. Date: Jul. 28, 2022

(54) RELAY PROTECTION SYSTEM RISK ASSESSMENT AND FAULT POSITIONING METHOD AND APPARATUS, AND DEVICE AND MEDIUM

(71) Applicant: CHINA ELECTRIC POWER RESEARCH INSTITUTE COMPANY LIMITED, Beijing (CN)

(72) Inventors: Wenhuan WANG, Beijing (CN); Peng GUO, Beijing (CN); Rongrong ZHAN, Beijing (CN); Lie ZHANG, Beijing (CN); Yanfei LI, Beijing (CN); Guosheng YANG, Beijing (CN); Limin WANG, Beijing (CN); Yiqun KANG, Beijing (CN); Hanfang ZHANG, Beijing (CN); Zhoutian YAN, Beijing (CN)

(21) Appl. No.: 17/603,507

(22) PCT Filed: Nov. 13, 2019
(86) PCT No.: PCT/CN2019/117973

§ 371 Date: Oct. 13, 2021

(30) Foreign Application Priority Data
Apr. 18, 2019 (CN) 201910313700.9

(51) Int. Cl. G06F 11/07; G06N 7/00

(52) U.S. Cl. CPC G06F 11/0754; G06N 7/005; G06F 11/0736

(57) ABSTRACT

Disclosed are a relay protection system risk assessment and fault positioning method and apparatus, and a device and a medium. The method comprises: dividing multiple fault events of a relay protection system into different hierarchical events, and constructing a fault tree of the relay protection system according to the different hierarchical events; converting the different hierarchical events of the fault tree into different nodes of an initial Bayesian network; giving multiple states to each node of the initial Bayesian network, and constructing a target Bayesian network according to a pre-constructed Bayesian network conditional probability distribution table and the multiple states of each node; determining the probability of an intermediate node in different states and the probability of a leaf node in a target Bayesian network in different states according to the prior probability of a root node in different states to complete risk assessment of the relay protection system; and determining the posterior probability of the state of the root node by using the Bayesian network according to the state of the leaf node, and completing fault positioning of the relay protection system.

### CROSS-REFERENCE TO RELATED APPLICATION

This application claims priority to China patent application No. 201910313700.9, filed with China National Intellectual Property Administration on Apr. 18, 2019, the disclosure of which is hereby incorporated by reference in its entirety.

### TECHNICAL FIELD

The present disclosure relates to the field of safety of power systems, and relates to a risk evaluation and fault positioning method and apparatus for a relay protection system, and a device and a medium, for example.

### BACKGROUND

Relay protection is the first line of defense for safe operation of a power grid. Proposing a risk assessment and fault positioning method for a relay protection system is of great significance for timely discovering potential safety hazard of the relay protection system and improving the safe operation of the power grid. In related technologies, researches have been carried out on evaluation of relay protection statuses, and certain results have been achieved in extraction of evaluation indicators, indicator weights, evaluation methods, and other aspects, and an enterprise standard “Guidelines for the Evaluation of Relay Protection Statuses” has been made, thus realizing comprehensive evaluation for the relay protection system from different perspectives and obtaining abnormality information of the relay protection system at the same time, so that valuable information can be provided for prewarning of a relay protection risk. In order to know the degree of risk of the relay protection system and determine a sequence of investigation of different potential hazard under abnormality conditions of the relay protection system, it is in an urgent need for providing a risk assessment and fault positioning method for a relay protection system.

### SUMMARY

The present disclosure provides a risk evaluation and fault positioning method and apparatus for a relay protection system, and a device and a medium, which meet the requirements for risk evaluation and fault positioning for the relay protection system.

The present disclosure provides a risk evaluation and fault positioning method for a relay protection system, which includes: dividing a plurality of fault events of the relay protection system into different hierarchy events, and constructing a fault tree of the relay protection system according to the different hierarchy events; transforming the different hierarchy events in the fault tree into different nodes of an initial Bayesian network, the different nodes including a root node, a leaf node and an intermediate node; endowing each node of the initial Bayesian network with a plurality of statuses; constructing a target Bayesian network according to a pre-built Bayesian network conditional probability distribution table and the plurality of statuses of each node; and determining, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determining, according to a status of the leaf node in the target Bayesian network, a posterior probability of a status of the root node in the target Bayesian network by using the target Bayesian network to complete fault positioning for the relay protection system.

The present disclosure further provides a risk evaluation and fault positioning apparatus for a relay protection system, which includes: a fault tree construction unit, configured to divide a plurality of fault events of the relay protection system into different hierarchy events, and construct a fault tree of the relay protection system according to the different hierarchy events; a Bayesian network construction unit, configured to transform the different hierarchy events in the fault tree into different nodes of an initial Bayesian network, the different nodes including a root node, a leaf node and an intermediate node; endow each node of the initial Bayesian network with a plurality of statuses; construct a target Bayesian network according to a pre-built Bayesian network conditional probability distribution table and the plurality of statuses of each node; and an evaluation and positioning unit, configured to determine, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determine, according to a status of the leaf node in the target Bayesian network, a posterior probability of a status of the root node in the target Bayesian network by using the target Bayesian network to complete fault positioning for the relay protection system.

The present disclosure further provides a device including a processor and a memory. The memory stores a computer program which, when executed by the processor, implements the method provided in any embodiment of the present disclosure.

The present disclosure further provides a computer storage medium storing a computer program. The computer program, when executed by a processor, implements the method provided in any embodiment of the present disclosure.

### BRIEF DESCRIPTION OF THE DRAWINGS

FIG. 1 is a flow chart of a risk evaluation and fault positioning method for a relay protection system provided by an embodiment of the present disclosure.

FIG. 2 is an example of Bayesian network probability calculation provided by an embodiment of the present disclosure.

FIG. 3 is an abnormality warning fault tree of a relay protection system provided by an embodiment of the present disclosure.

FIG. 4 is a schematic diagram of transforming a fault tree into a Bayesian network provided by an embodiment of the present disclosure.

FIG. 5 is a schematic diagram of a risk evaluation and fault positioning apparatus for a relay protection system provided by an embodiment of the present disclosure.

FIG. 6 is a schematic structural diagram of a device provided by an embodiment of the present disclosure.

### DETAILED DESCRIPTION

The technical solutions provided by the present disclosure are described in the following descriptions to facilitate understanding the present disclosure.

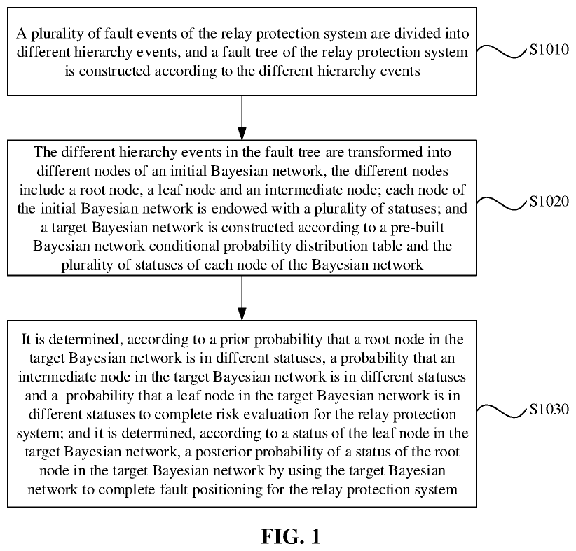

Referring to FIG. 1, FIG. 1 is a flow chart of a risk evaluation and fault positioning method for a relay protection system provided by an embodiment of the present disclosure, the method provided by the embodiment of the present disclosure is described below in combination with FIG. 1.

At S1010, a plurality of fault events of the relay protection system are divided into different hierarchy events, and a fault tree of the relay protection system is constructed according to the different hierarchy events.

Starting from a fault of the relay protection system, a fault cause is advanced layer by layer, and the plurality of fault events of the relay protection system are divided into a top event, a bottom event and an intermediate event. In an embodiment, an abnormality warning event occurring in the relay protection system is set to be the top event; an abnormality warning event for decomposing a fault cause to an apparatus included in the relay protection system is set to be the intermediate event. The apparatus is a relay protection apparatus, an intelligent terminal, a combination unit and the like, for example; and an abnormality warning event for decomposing a fault cause of each apparatus into each apparatus is set to be the bottom event. Thus, the fault tree of the relay protection system is constructed according to the different hierarchy events. The fault tree includes three types of hierarchy events: a top event, a bottom event, and an intermediate event.

At S1020, the different hierarchy events in the fault tree are transformed into different nodes of an initial Bayesian network, the different nodes include a root node, a leaf node and an intermediate node; each node of the initial Bayesian network is endowed with a plurality of statuses; and a target Bayesian network is constructed according to a pre-built Bayesian network conditional probability distribution table and the plurality of statuses of each node of the Bayesian network.

The top event, the bottom event and the intermediate event of the fault tree are respectively transformed into the leaf node, the root node and the intermediate node of the initial Bayesian network. Each node of the initial Bayesian network is then endowed with the plurality of statuses. In an embodiment, there may be three statuses: severe abnormality, abnormality and normality.

At this step, distribution characteristics and parameters of relay protection abnormality warning are determined by counting the same abnormality warnings occurring in the apparatuses of the same model in the same manufacturer in history, and then the probability of occurrence of the abnormality warning is then calculated according to the operation time of an apparatus to be studied and is used as the prior probability of the root node of the initial Bayesian network. The abnormality warning may not occur in a life cycle of a sample, and test data has the characteristics of random truncation. Assuming that the number of samples is n, there are a total of r samples among the n samples that have abnormality warning. For these r samples, the abnormality warning occurrence time relative to the apparatus commissioning time is tⁱ, i.e., a difference between the abnormality warning occurrence time and the apparatus commissioning time, i=1, 2, . . . , r; a total of k samples among the n samples have no abnormality warning, where cⱼ is the truncation time of the samples that have no abnormality warning, i.e., a difference between the sample withdrawal time and the commissioning time, j=1, 2, . . . , k. Since an exponential distribution has a high degree of fitting for the occurrence of the abnormality warning, a frequency of occurrence of the abnormality warning, i.e., the maximum likelihood estimate of a failure rate λ, is:

$$λ = \frac{{\sum }_{i = 1}^{r} {t}_{i} + {\sum }_{j = 1}^{k} {c}_{j}}{r} . \qquad ( 1 )$$

For abnormality warning that does not occur in history in apparatuses of the same model in the same manufacturer, the probability that the root node is in a normal state is 1, and the root node is removed from the initial Bayesian network to construct the target Bayesian network.

The value of a failure probability is:

F(t)=1−e^{-λ(t-tm)} (2);

where t is the present time, and tₘ is the maximum value of the apparatus commissioning time, the last full inspection time, and the last occurrence time of the same abnormality warning event.

The fault tree is similar to the structure of the Bayesian network. The top event, the bottom event, and the intermediate event of the fault tree correspond to the leaf node, the root node and the intermediate node of the Bayesian network. A logic gate of the fault tree may be transformed into a directed edge. The logic is illustrated by the conditional probability distribution table. The events in the fault tree only have two states: occurrence and non-occurrence. In order to reflect the difference of severities of the abnormality warning of the apparatus, a multi-status model is built for the nodes in the Bayesian network, including three statuses “severe abnormality”, “abnormal”, and “normal”. In fact, the root node still has only two statuses, i.e., “abnormality occurred” and “abnormality not occurred”. When three statuses are used for modeling, if “severe abnormality” or “abnormal” are consistent with the severity of the abnormality warning of the root node, the probability is taken as the prior probability; and if no, the probability is 0, and the probability of “normal” is a probability that no abnormality warning occurs.

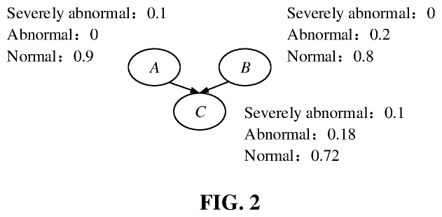

Logic of the Bayesian network conditional probability distribution table satisfies formulas (3)-(5).

$$\begin{matrix} P ( N = {N}^{3} ) = \{ \begin{matrix}1 , if there is P ( M = {M}^{3} ) > 0 \\ 0 , if all P ( M = {M}^{3} ) = 0\end{matrix} & ( 3 ) \\ P ( N = {N}^{2} ) = \{ \begin{matrix}1 , if there is P ( M = {M}^{2} ) > 0 and P ( M ) = 0 \\ 0 , if there is no P ( M = {M}^{2} ) > 0 and P ( M = {M}^{3} ) = 0\end{matrix} & ( 4 ) \\ P ( N = {N}^{1} ) = 1 - P ( N = {N}^{2} ) - P ( N = {N}^{3} ) ; & ( 5 )\end{matrix}$$

where P(N=Nⁱ) represents a probability that a node N is in a status i; P(M=Mⁱ) represents a probability that a father node M of the node N is in the status i, i=1, 2, 3; status 1 means normal, status 2 means abnormal, and status 3 means severely abnormal. A local Bayesian network used for analyzing the failure probability of a line relay protection apparatus is taken as an example. As illustrated in FIG. 2, assuming that A corresponds to whether line protection TA disconnection (severe abnormality) occurs, and B corresponds to whether line protection channel warning (ordinarily abnormal) occurs, and C corresponds to the status of the line relay protection apparatus, if the prior probabilities of the line protection TA disconnection and the line protection channel warning is 0.1 and 0.2, respectively, it may be obtained that the probabilities that multiple nodes of the Bayesian network are in different statuses are illustrated in FIG. 2.

At S1030, it is determined, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and it is determined, according to a status of the leaf node in the target Bayesian network, a posterior probability of a status of the root node in the target Bayesian network by using the target Bayesian network to complete fault positioning for the relay protection system.

If the abnormality severity of the relay protection system is higher, the risk of the relay protection system is larger, the probability of abnormality warning is larger, and the risk is also larger.

In an embodiment, the risk R of the relay protection system may be expressed by a product of the possibility P of occurrence of abnormality warning and the severity S; where P is reflected by the probability of abnormality warning, and S is reflected by the three statuses: “severe abnormality”, “abnormality” and “normality”.

In an embodiment, a probability that a node X of the Bayesian network is at a status i is:

$$P ( X = {X}^{i} ) \\ = \sum P ( {y}_{1} , … , {y}_{m} ; X = {X}^{i} ) \\ = {\sum }_{{k}_{1} , … , {k}_{m}} [ P ( X = {X}^{i} \vert {y}_{1} = {y}_{1}^{{k}_{1}} , … , {y}_{m} = {y}_{m}^{{k}_{m}} ) P ( {y}_{1} = {y}_{1}^{{k}_{1}} ) … P ( {y}_{m} = {y}_{m}^{{k}_{m}} ) ] ; \qquad ( 6 )$$

where P(X=Xⁱ) is a probability that a node X is in a status i; yⱼ is a farther node of the node X, j=1, 2, . . . , m; P(yⱼJ=yⱼ^{k}^{ⱼ}) is a probability that a node yᵢ is in a status kⱼ; P(X=Xⁱ|yₗ=yₗ^{k}^{ⱼ}, . . . , yₘ=yₘ^{k}^{ₘ}) is determined according to the Bayesian network conditional probability distribution table, as illustrated in formulas (3)-(5); i=1, 2, 3, kⱼ=1, 2, 3; state 1 means normal, status 2 means abnormal, and status 3 means severely abnormal; and k₁, . . . , kₘ is a status permutation and combination of y₁, . . . , yₘ. The root node is used as the farther node, and the probability that nodes taking the root node as the father node are in different statuses is determined by using formula (6) according to the prior probability of the root node. The following steps are repeatedly executed until determining the probability that the leaf node is in different the statuses: the newly obtained node with the probability of being in different statuses is used as the father node, and the probability that the nodes taking this node as the father node are in different statuses by using formula (6).

In an embodiment, there are two farther nodes of the node X, i.e., y₁ and y₂, and the probability that X is in an abnormal state is determined as:

$$P ( X = {X}^{2} ) \\ = \sum P ( {y}_{1} , {y}_{2} ; X = {X}^{i} ) \\ = {\sum }_{{k}_{1} , {k}_{2}} [ P ( X = {X}^{2} \vert {y}_{1} = {y}_{1}^{{k}_{1}} , {y}_{2} = {y}_{2}^{{k}_{2}} ) P ( {y}_{1} = {y}_{1}^{{k}_{1}} ) P ( {y}_{2} = {y}_{2}^{{k}_{2}} ) ] .$$

In the above formula, k₁ and k₂ are the status permutation and combination of y₁ and y₂. Since values of k₁ and k₂ are in a range of {1, 2, 3}, there are 9 status permutations and combinations for k₁ and k₂. In the above formula, it is necessary to calculate a calculation result of P(X=X²|y₁=y₁^{k}^{₁}, y₂=y₂^{k}^{₂})P(y₁=y₁^{k}^{₁})P(y₂=y₂^{k}^{₂}) in each status permutation and combination, and the 9 calculation results obtained are added to obtain the probability that X is in the abnormal status.

Under a condition that a status i (i=1, 2, 3) of a leaf node T is known, the Bayesian formula is used to calculate a probability that a root node Zⱼ (j=1, . . . , n) is in a status sⱼ:

$$P ( {Z}_{j} = {Z}_{j}^{{s}_{j}} \vert T = {T}^{i} ) = \frac{P ( {Z}_{j} = {Z}_{j}^{{s}_{j}} , T = {T}^{i} )}{P ( T = {T}^{i} )} ; \qquad ( 7 )$$

where P(Zⱼ=Zⱼ^{s}^{ⱼ}|T=Tⁱ) is a probability that the root node Zⱼ is in the status sⱼ and the status of the leaf node T is Tⁱ, i=1, 2, 3, sⱼ=1, 2, 3; state 1 means normal, status 2 means abnormal, and status 3 means severely abnormal. The above formula is used to calculate the posterior probability of the root node Z₁ to realize the fault positioning for the relay protection system.

According to the embodiments of the present disclosure, the fault tree of the relay protection system is constructed and is then transformed into the Bayesian network; the prior probability of a relay protection abnormality warning root node is determined through the Bayesian network, the probability that the intermediate node is in different statuses is obtained according to the prior probability of the root node, and the posterior probability of the status of the root node is determined according to the status of the leaf node, thus realizing the risk evaluation and fault positioning for the relay protection system.

The risk evaluation and fault positioning method for the relay protection system provided by the present disclosure is described below through examples. The description is as follows.

At 10, a fault tree of the relay protection system is constructed.

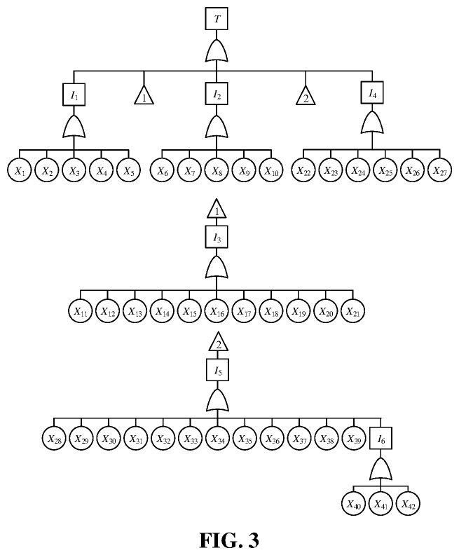

A single set of a 220 kV-line protection system is taken as a study object. The system includes two combination unit apparatuses, one line protection apparatus, one intelligent terminal apparatus, and one bus protection apparatus. The construction of the abnormality warning fault tree of the relay protection system is as illustrated in FIG. 3. Meanings of the symbols in the fault tree are as illustrated in Table 1.

TABLE 1

| Symbol | Event |
|---|---|
| T | Abnormality |
| | warning of the relay |
| | protection system |
| I1 | Abnormality |
| | warning of the bus |
| | combination unit |
| I2 | Abnormality |
| | warning of the line |
| | combination unit |
| I3 | Abnormality |
| | warning of line |
| | protection |
| I4 | Abnormality |
| | warning of the |
| | intelligent terminal |
| I5 | Abnormality |
| | warning of bus |
| | protection |
| X1 X6 | Abnormality of the |
| | combination unit |
| | apparatus |
| X2 X7 | Shutting of the |
| | combination unit |
| | apparatus |
| X3 X8 | Abnormality |
| | warning of |
| | combination unit |
| | synchronization |
| X4, X9 | Maintenance status |
| | of the combination |
| | unit |
| X5 | GOOSE |
| X10 | disconnection of |
| | combination unit |
| | received intelligent |
| | terminal |
| X11 | Shutting of the line |
| | protection apparatus |
| X12 | Power loss warning |
| | of the line |
| | protection apparatus |
| X13 | SV sampling |
| | abnormality of line |
| | protection |
| X14 | SV interruption of |
| | the line protection |
| | received |
| | combination unit |
| X15 | Line protection TA |
| | disconnection |
| X16 | Line protection TV |
| | disconnection |
| X17 | GOOSE |
| | interruption of line |
| | protection received |
| | intelligent terminal |
| X18 | GOOSE |
| | interruption of line |
| | protection received |
| | bus differential |
| | protection |
| X19 | Line protection |
| | channel warning |
| X20 | Turn-on and turn- |
| | off abnormality of |
| | line protection |
| X21 | Warning of |
| X25 | maintenance |
| X38 | inconsistency |
| X22 | Shutting of the |
| | intelligent terminal |
| X23 | GOOSE |
| | disconnection of |
| | intelligent terminal |
| | xx |
| X24 | Clock |
| | synchronization |
| | abnormality of the |
| | intelligent terminal |
| X26 | Disconnection of |
| | the intelligent |
| | terminal control |
| | loop |
| X27 | Pressure |
| | abnormality of the |
| | circuit breaker |
| X28 | Shutting of the bus |
| | protection |
| | apparatus |
| X29 | Power loss warning of |
| | the bus protection |
| | apparatus |
| X30 | SV sampling |
| | abnormality of bus |
| | protection xx branch |
| X31 | SV interruption of bus |
| | protection xx branch |
| X32 | TA interruption of bus |
| | protection xx branch |
| X33 | TA disconnection of xx |
| | buscouple/segmentation |
| | of bus protection |
| X34 | TV disconnection of xx |
| | segment of bus of bus |
| | protection |
| X35 | GOOSE interruption of |
| | bus protection received |
| | intelligent terminal |
| X36 | GOOSE interruption of |
| | bus protection received |
| | line protection |
| X37 | Turn-on and turn-off |
| | abnormality of bus |
| | protection |
| X39 | 220 kV bus |
| | interconnection |
| I6 | Operation abnormality |
| | of bus protection |
| X40 | Non-correspondence to |
| | the position of the bus |
| | differential protection |
| | isolation switch |
| X41 | Mis-start of a failed |
| | contact |
| X42 | Non-correspondence of |
| | a buscouple |
| | segmentation contact |

At 20, a prior probability of the relay protection abnormality warning root node is determined.

For each apparatus, apparatuses with sufficiently reported historical abnormality warning information are selected from apparatuses of the same model in the same manufacturer, multiple abnormality warning events of the apparatuses and the occurrence time of multiple abnormality warning events are used as samples. Formula (1) is used to calculate a failure rate 2 of various abnormality warnings occurring in the apparatus, and formula (2) is used to calculate the occurrence probability of various abnormality warning at the present operation time of the apparatus. The occurrence probability and severity of various abnormality warnings in the 220 kV protection system are as illustrated in Table 2. For one abnormality warning that has not occurred in history, it will not appear in the Bayesian network.

TABLE 2

| | | | Prior |
|---|---|---|---|
| | | | probability |
| Symbol | Event | Severity | (×10-6) |
| X1 | Abnormality | Moderate | 11.23 |
| | of the | | |
| | combination | | |
| | unit | | |
| | apparatus | | |
| X2 | Shutting | Severe | 0.54 |
| | of the | | |
| | combination | | |
| | unit | | |
| | apparatus | | |
| X3 | Abnormality | Moderate | 3.29 |
| | warning of | | |
| | combination | | |
| | unit | | |
| | synchronization | | |
| X4 | Maintenance | Moderate | 1.64 |
| | status of the | | |
| | combination | | |
| | unit | | |
| X5 | GOOSE | Moderate | 0 |
| | disconnection | | |
| | of | | |
| | combination | | |
| | unit received | | |
| | intelligent | | |
| | terminal | | |
| X6 | Abnormality | Moderate | 9.76 |
| | of the | | |
| | combination | | |
| | unit | | |
| | apparatus | | |
| X7 | Shutting | Severe | 0 |
| | of the | | |
| | combination | | |
| | unit | | |
| | apparatus | | |
| X8 | Abnormality | Moderate | 2.46 |
| | warning of | | |
| | combination | | |
| | unit | | |
| | synchronization | | |
| X9 | Maintenance | Moderate | 1.33 |
| | status of the | | |
| | combination | | |
| | unit | | |
| X10 | GOOSE | Moderate | 0.33 |
| | disconnection | | |
| | of | | |
| | combination | | |
| | unit received | | |
| | intelligent | | |
| | terminal | | |
| X11 | Shutting of | Severe | 0 |
| | the line | | |
| | protection | | |
| | apparatus | | |
| X12 | Power loss | Severe | 0 |
| | warning of | | |
| | the line | | |
| | protection | | |
| | apparatus | | |
| X13 | SV sampling | Severe | 0.71 |
| | abnormality | | |
| | of line | | |
| | protection | | |
| X14 | SV | Severe | 0.59 |
| | interruption | | |
| | of the line | | |
| | protection | | |
| | received | | |
| | combination | | |
| | unit | | |
| X15 | Line | Moderate | 0 |
| | protection | | |
| | TA | | |
| | disconnection | | |
| X16 | Line | Moderate | 1.78 |
| | protection | | |
| | TV | | |
| | disconnection | | |
| X17 | GOOSE | Moderate | 0 |
| | interruption | | |
| | of line | | |
| | protection | | |
| | received | | |
| | intelligent | | |
| | terminal | | |
| X18 | GOOSE | Moderate | 0 |
| | interruption | | |
| | of line | | |
| | protection | | |
| | received bus | | |
| | differential | | |
| | protection | | |
| X19 | Line | Moderate | 3.26 |
| | protection | | |
| | channel | | |
| | warning | | |
| X20 | Turn-on and | Moderate | 4.11 |
| | turn-off | | |
| | abnormality | | |
| | of line | | |
| | protection | | |
| X21 | Warning of | Moderate | 2.93 |
| | maintenance | | |
| | inconsistency | | |
| X22 | Shutting of the | Severe | 0 |
| | intelligent | | |
| | terminal | | |
| X23 | GOOSE | Moderate | 0 |
| | disconnection | | |
| | of intelligent | | |
| | terminal xx | | |
| X24 | Clock | Moderate | 1.11 |
| | synchronization | | |
| | abnormality | | |
| | of the | | |
| | intelligent | | |
| | terminal | | |
| X25 | Warning of | Moderate | 0 |
| | maintenance | | |
| | inconsistency | | |
| X26 | Disconnection | Severe | 0.66 |
| | of the | | |
| | intelligent | | |
| | terminal | | |
| | control | | |
| | loop | | |
| X27 | Pressure | Severe | 0 |
| | abnormality | | |
| | of the | | |
| | circuit | | |
| | breaker | | |
| X28 | Shutting | Severe | 0 |
| | of the bus | | |
| | protection | | |
| | apparatus | | |
| X29 | Power loss | Severe | 0 |
| | warning | | |
| | of the bus | | |
| | protection | | |
| | apparatus | | |
| X30 | SV sampling | Severe | 0.44 |
| | abnormality | | |
| | of bus | | |
| | protection xx | | |
| | branch | | |
| X31 | SV interruption | Severe | 0.26 |
| | of bus | | |
| | protection xx | | |
| | branch | | |
| X32 | TA interruption | Moderate | 0.59 |
| | of bus | | |
| | protection xx | | |
| | branch | | |
| X33 | TA | Moderate | 0 |
| | disconnection | | |
| | of xx | | |
| | buscouple/ | | |
| | segmentation | | |
| | of bus | | |
| | protection | | |
| X34 | TV | Moderate | 0 |
| | disconnection | | |
| | of xx | | |
| | segment of | | |
| | bus of bus | | |
| | protection | | |
| X35 | GOOSE | Moderate | 0 |
| | interruption | | |
| | of bus | | |
| | protection | | |
| | received | | |
| | intelligent | | |
| | terminal | | |
| X36 | GOOSE | Moderate | 0 |
| | interruption | | |
| | of bus | | |
| | protection | | |
| | received | | |
| | line protection | | |
| X37 | Turn-on | Moderate | 1.26 |
| | and turn-off | | |
| | abnormality of | | |
| | bus protection | | |
| X38 | Warning of | Moderate | 3.41 |
| | maintenance | | |
| | inconsistency | | |
| X39 | 220 kV bus | Moderate | 0 |
| | interconnection | | |
| X40 | Non- | Moderate | 0 |
| | correspondence | | |
| | to the | | |
| | position of the | | |
| | bus differential | | |
| | protection | | |
| | isolation | | |
| | switch | | |
| X41 | Mis-start of a | Moderate | 0 |
| | failed contact | | |
| X42 | Non- | Moderate | 0 |
| | correspondence | | |
| | of a buscouple | | |
| | segmentation | | |
| | contact | | |

At 30, the fault tree is transformed into the Bayesian network.

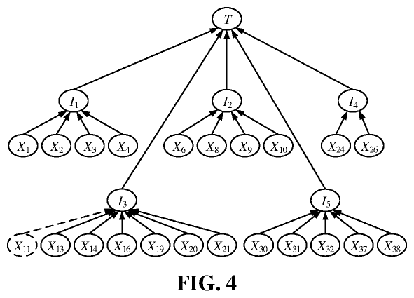

The prior probability of various statuses of the root node of the Bayesian network corresponding to the abnormality warning bottom event in the fault tree is determined according to the severity and occurrence rate of the various abnormality warnings in the apparatus, and the Bayesian network conditional probability distribution table is determined according to formulas (3)-(5). The fault tree is transformed into the Bayesian network, as illustrated in FIG. 4.

At 40, the risk evaluation and fault positioning are performed on the relay protection system.

Starting from the prior probability of the root nodes (X₁-X₄₂) of the Bayesian network, the probabilities of the intermediate nodes (I₁-I₆) in the network in different statuses are calculated in turn, and the probability of the leaf node T in different statuses is obtained. The calculation results are as illustrated in Table 3. According to the calculation results, it is determined that the probability that the single set of 220 kV line protection system has severe abnormality is 3.2×10⁻⁶, and the probability of moderate abnormality is 47.49×10⁻⁶, thus realizing the risk evaluation for the relay protection system.

TABLE 3

| Status | I1 | I2 | I3 | I4 | I5 | I6 | T |
|---|---|---|---|---|---|---|---|
| Severe | 0.54 | 0 | 1.3 | 0.66 | 0.7 | 0 | 3.2 |
| Moderate | 16.16 | 13.88 | 12.08 | 0.11 | 5.26 | 0 | 47.49 |
| Normal | 999,983.3 | 999,986.12 | 999,986.62 | 999,999.23 | 999,994.04 | 1,000,000 | 999,949.31 |

At one moment, the 220 kV protection system has the serious abnormality. The probability that the numerators, that is, the root node and the leaf node, are both in a severely abnormal status in formula (7) is illustrated in Table 4. The denominator of formula (7), i.e., the probability that the system is in a severely abnormal status is 3.2×10⁻⁶. Based on this, the posterior probability that the root node has a severe abnormality under the condition that the leaf node has a severe abnormality may be calculated, as illustrated in Table 4. According to Table 4, the possibility of occurrence of different abnormality warnings may be determined, so as to determine an order of investigation. For abnormality warning with a moderate severity or a priori probability of 0 in Table 2, since the probability that the root node is in a severely abnormal status is 0, it does not appear in Table 4.

TABLE 4

| Node | X2 | X13 | X14 | X26 | X30 | X31 |
|---|---|---|---|---|---|---|
| Numerator (×10-6) | 0.54 | 0.71 | 0.59 | 0.66 | 0.44 | 0.26 |
| of formula (7) | | | | | | |
| Posterior | 16.9 | 22.2 | 18.4 | 20.6 | 13.8 | 8.1 |
| probability (%) | | | | | | |

If a set of apparatus of the same model in the same manufacturer as the line protection apparatus of the 220 kV protection system (not the protection apparatus in this system) has had the X₁₁ apparatus shutting recently, the warning information will be added to the abnormality warning sample library of the apparatus of this model to correct the failure rate 2 of different abnormality warnings. The prior probability of other abnormality warnings remains unchanged. The prior probability of X₁₁ becomes 0.77×10⁻⁶ after calculation. The node X₁₁ is added to the Bayesian network, as illustrated by the dotted line in FIG. 4, and the probabilities that the non-root nodes of the Bayesian network are in different statuses and the posterior probability of the root node under the condition that the system has the severe abnormality are re-calculated, and results are as illustrated in Table 5a and Table 5b.

TABLE 5a
Probabilities that the non-root nodes are in different statuses in the Bayesian network (×10⁻⁶)

| Status | I1 | I2 | I3 | I4 | I5 | I6 | T |
|---|---|---|---|---|---|---|---|
| Severe | 0.54 | 0 | 2.07 | 0.66 | 0.7 | 0 | 3.97 |
| Moderate | 16.16 | 13.88 | 12.08 | 0.11 | 5.26 | 0 | 47.49 |
| Normal | 999,983.3 | 999,986.12 | 999,985.85 | 999,999.23 | 999,994.04 | 1,000,000 | 999,948.54 |

TABLE 5b
Posterior probability that the root node
is in a severely abnormal state under the condition
that the leaf node has the severe abnormality

| Node | X2 | X13 | X14 | X26 | X30 | X31 |
|---|---|---|---|---|---|---|
| Numerator (×10-6) | 0.54 | 0.71 | 0.59 | 0.66 | 0.44 | 0.26 |
| of formula (7) | | | | | | |
| Posterior | 16.9 | 22.2 | 18.4 | 20.6 | 13.8 | 8.1 |
| probability (%) | | | | | | |

Before shutting warning of the line protection apparatus of the same model in the same manufacturer occurs, the priori probability of the abnormality warning of the root node X₁₁ is calculated to be 0, and this node is removed from the Bayesian network. After the shutting warning of the line protection apparatus occurs and is collected into the sample library, the priori probability of X₁₁ is re-calculated to be 0.77×10⁻⁶, and the root node X₁₁ is added into the Bayesian network again. The change in the prior probability of X₁₁ leads to an increase in the probability that a child node 13 of X₁₁ and the root node T of the Bayesian network are in a severely abnormal status. Under the condition that the leaf node has the severe abnormality, the posterior probability that a plurality of root nodes are in a severely abnormal status also changes.

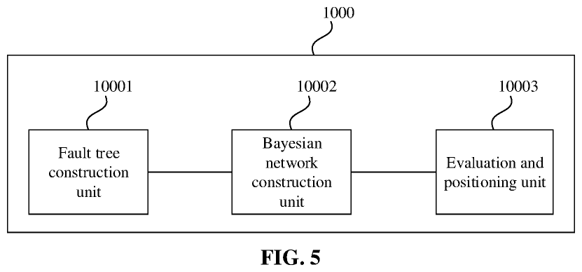

Corresponding to the risk evaluation and fault positioning method for the relay protection system, the present disclosure further provides a risk evaluation and fault positioning apparatus 1000 for a relay protection system, as illustrated in FIG. 5, which includes: a fault tree construction unit 10001, a Bayesian network construction unit 10002 and an evaluation and positioning unit 10003.

The fault tree construction unit 10001 is configured to divide a plurality of fault events of the relay protection system into different hierarchy events, and construct a fault tree of the relay protection system according to the different hierarchy events.

The Bayesian network construction unit 10002 is configured to transform the different hierarchy events in the fault tree into different nodes of an initial Bayesian network, the different nodes including a root node, a leaf node and an intermediate node; endow each node of the initial Bayesian network with a plurality of statuses; construct a target Bayesian network according to a pre-built Bayesian network conditional probability distribution table and the plurality of statuses of each node.

The evaluation and positioning unit 10003 is configured to determine, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determine, according to a status of the leaf node in the target Bayesian network, a posterior probability of a status of the root node in the target Bayesian network by using the target Bayesian network to complete fault positioning for the relay protection system.

The present disclosure applies the fault tree and the Bayesian network to realize the risk evaluation and the fault positioning for the relay protection system. A multi-layer system of relay protection system faults is constructed by applying the cause analysis performance of the fault tree, with clear structure and clear relationships. By transforming the fault tree into the Bayesian network, modeling of the severity and probability of abnormal warnings is completed, and the probability that the relay protection system is abnormal is calculated by using a conditional probability distribution table and Bayesian formulas to realize the risk evaluation. Meanwhile, the posterior probability that various abnormalities occur under the fault condition that the relay protection system has different severe faults is proposed, thus realizing the fault positioning. The method provided herein may significantly improve the analysis and evaluation level of the relay protection system, and meets the present need for the risk evaluation and fault positioning method for the relay protection system.

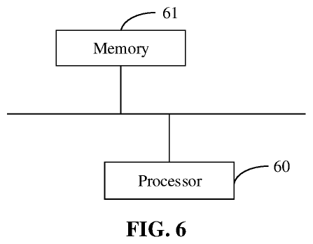

FIG. 6 is a schematic structural diagram of a device provided by an embodiment of the present disclosure. As illustrated in FIG. 6, the device includes a processor 60 and a memory 61. The number of the processor 60 in the device may be one or multiple. In FIG. 6, one processor 60 is taken as an example. The processor 60 and the memory 61 in the device may be connected through a bus or in other way. In FIG. 6, bus connection is taken as an example.

The memory 61 is used as a computer-readable storage medium that may be set to be storage software, a computer-executable program and a module, such as a program instruction/module corresponding to the risk evaluation and fault positioning method for the relay protection system in the embodiments of the present disclosure. The processor 60 executes at least one functional application and data processing of the device by running software programs, instructions, and modules stored in the memory 61.

The memory 61 may mainly include a program storage region and a data storage region. In the memory 61, the program storage region may store an operating system and an application program required by at least one function. The data storage region may store data created according to the use of a terminal, etc. In addition, the memory 61 may include a high-speed random access memory, and may further include a non-volatile memory, such as at least one magnetic disk storage device, a flash memory device, or other non-volatile solid-state storage devices. In some examples, the memory 61 may include a memory remotely provided with respect to the processor 60, and these remote memories may be connected to the device through a network. Examples of the above network include, but are not limited to, the Internet, an intranet, a local area network, a mobile communication network, and combinations thereof.

The embodiments of the present disclosure also provide a storage medium including computer-executable instructions which, when executed by a processor of a computer, execute the method provided in any embodiment of the present disclosure.

The storage medium provided in the present embodiment and including the computer-executable instructions, and the computer-executable instructions are not limited to operations of the method described above, and may also perform related operations in the methods provided in any embodiment of the present disclosure.

The present disclosure can be implemented by means of software and general-purpose hardware, and can also be implemented by hardware. Based on this understanding, the technical solutions of the present disclosure can be embodied in the form of a software product, and the computer software product can be stored in a computer-readable storage medium, such as a computer floppy disk, a read-only memory (ROM), a random access memory (RAM), a flash memory (FLASH), a hard disk, an optical disk or the like, including multiple instructions to make a computer device (which can be a personal computer, server, network device, or the like) execute the method of any embodiment of the present disclosure.

1. A risk evaluation and fault positioning method for a relay protection system, comprising:
dividing a plurality of fault events of the relay protection system into different hierarchy events, and constructing a fault tree of the relay protection system according to the different hierarchy events;
transforming the different hierarchy events in the fault tree into different nodes of an initial Bayesian network, the different nodes including a root node, a leaf node and an intermediate node; endowing each node of the initial Bayesian network with a plurality of statuses; constructing a target Bayesian network according to a pre-built Bayesian network conditional probability distribution table and the plurality of statuses of each node; and
determining, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determining, according to a status of the leaf node in the target Bayesian network, a posterior probability of a status of the root node in the target Bayesian network by using the target Bayesian network to complete fault positioning for the relay protection system.

2. The method of claim 1, wherein the dividing the plurality of fault events of the relay protection system into the different hierarchy events comprises:
dividing the plurality of fault events of the relay protection system into a top event, a bottom event and an intermediate event.

3. The method of claim 2, wherein the dividing the plurality of fault events of the relay protection system into the top event, the bottom event and the intermediate event comprises:
setting an abnormality warning event occurring in the relay protection system to be the top event; setting an abnormality warning event for decomposing a fault cause to an apparatus included in the relay protection system to be the intermediate event; and setting an abnormality warning event for decomposing a fault cause of each apparatus into each apparatus to be the bottom event.

4. The method of claim 2, wherein the transforming the different hierarchy events in the fault tree into the different nodes of the initial Bayesian network comprises:
respectively transforming the top event, the bottom event and the intermediate event of the fault tree into the leaf node, the root node and the intermediate node of the initial Bayesian network.

5. The method of claim 1, wherein the plurality of statuses comprises severe abnormality, abnormality and normality.

6. The method of claim 5, wherein logic of the Bayesian network conditional probability distribution table satisfies following formulas:
$$\begin{matrix} P ( N = {N}^{3} ) = \{ \begin{matrix}1 , if there is P ( M = {M}^{3} ) > 0 \\ 0 , if all P ( M = {M}^{3} ) = 0\end{matrix} ; \\ P ( N = {N}^{2} ) = \{ \begin{matrix}1 , if there is P ( M = {M}^{2} ) > 0 and P ( M ) = 0 \\ 0 , if there is no P ( M = {M}^{2} ) > 0 and P ( M = {M}^{3} ) = 0\end{matrix} ; \\ P ( N = {N}^{1} ) = 1 - P ( N = {N}^{2} ) - P ( N = {N}^{3} ) ;\end{matrix}$$
where P(N=Nⁱ) represents a probability that a node N is in a status i; P(M=Mⁱ) represents a probability that a father node M of the node N is in the status i, i=1, 2, 3; status 1 means normal, status 2 means abnormal, and status 3 means severely abnormal.

7. The method of claim 5, wherein the determining, according to the prior probability that the root node in the target Bayesian network is in the different statuses, the probability that the intermediate node in the target Bayesian network is in the different statuses and the probability that the leaf node in the target Bayesian network is in the different statuses comprises:
determining, by means of a following formula according to the prior probability that the root node in the target Bayesian network is in the different statuses, a probability that nodes taking the root node as a father node are in different statuses; repeatedly executing following steps until determining the probability that the leaf node in the target Bayesian network is in the different statuses: determining, by means of the following formula according to the probability that a target node is in different statuses, a probability that the nodes taking the target node as the father node are in different statuses, wherein the target node is a node that is determined last time and has a probability of different statuses;
$$P ( X = {X}^{i} ) \\ = \sum P ( {y}_{1} , … , {y}_{m} ; X = {X}^{i} ) \\ = {\sum }_{{k}_{1} , … , {k}_{m}} [ P ( X = {X}^{i} \vert {y}_{1} = {y}_{1}^{{k}_{1}} , … , {y}_{m} = {y}_{m}^{{k}_{m}} ) P ( {y}_{1} = {y}_{1}^{{k}_{1}} ) … P ( {y}_{m} = {y}_{m}^{{k}_{m}} ) ] ;$$
where P(X=Xⁱ) is a probability that a node X is in a status i; yⱼ is a farther node of the node X, j=1, m; P(yⱼ=yⱼ^{k}^{ⱼ}) is a probability that a node yᵢ is in a status kⱼ; P(X=Xⁱ| y₁=y₁^{k}^{ₗ}, . . . , yₘ=yₘ^{k}^{ₘ}) is determined according to the Bayesian network conditional probability distribution table; i=1, 2, 3, kⱼ=1, 2, 3; state 1 means normal, status 2 means abnormal, and status 3 means severely abnormal; and k₁, . . . , kₘ is a status permutation and combination of y₁, . . . yₘ.

8. The method of claim 5, wherein the determining, according to the status of the leaf node, the posterior probability of the status of the root node in the target Bayesian network by using the target Bayesian network comprises:
under a known condition that a leaf node Tis in a status i, calculating a posterior probability that a root node Zⱼ (j=1, . . . , n) in the target Bayesian network is in a status Sⱼ by using Bayesian formulas:
$$P ( {Z}_{j} = {Z}_{j}^{{s}_{j}} \vert T = {T}^{i} ) = \frac{P ( {Z}_{j} = {Z}_{j}^{{s}_{j}} , T = {T}^{i} )}{P ( T = {T}^{i} )} ;$$
where P(Zⱼ=Zⱼ^{s}^{ⱼ}|T=Tⁱ) is a probability that the root node Zⱼ is in the status sⱼ and the leaf node Tis in the status i, i=1, 2, 3, sⱼ=1, 2, 3; state 1 means normal, status 2 means abnormal, and status 3 means severely abnormal.

9. A risk evaluation and fault positioning apparatus for a relay protection system, comprising:
a processor; and
a memory for storing instructions executable by the processor;
wherein the processor is configured to:
divide a plurality of fault events of the relay protection system into different hierarchy events, and construct a fault tree of the relay protection system according to the different hierarchy events;
transform the different hierarchy events in the fault tree into different nodes of an initial Bayesian network, the different nodes including a root node, a leaf node and an intermediate node; endow each node of the initial Bayesian network with a plurality of statuses; construct a target Bayesian network according to a pre-built Bayesian network conditional probability distribution table and the plurality of statuses of each node; and
determine, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determine, according to a status of the leaf node in the target Bayesian network, a posterior probability of a status of the root node in the target Bayesian network by using the target Bayesian network to complete fault positioning for the relay protection system.

10. (canceled)

11. A non-transitory computer storage medium storing a computer program, wherein the computer program, when executed by a processor, implements a risk evaluation and fault positioning method for a relay protection system, comprising:
dividing a plurality of fault events of the relay protection system into different hierarchy events, and constructing a fault tree of the relay protection system according to the different hierarchy events;
transforming the different hierarchy events in the fault tree into different nodes of an initial Bayesian network, the different nodes including a root node, a leaf node and an intermediate node; endowing each node of the initial Bayesian network with a plurality of statuses; constructing a target Bayesian network according to a pre-built Bayesian network conditional probability distribution table and the plurality of statuses of each node; and
determining, according to a prior probability that a root node in the target Bayesian network is in different statuses, a probability that an intermediate node in the target Bayesian network is in different statuses and a probability that a leaf node in the target Bayesian network is in different statuses to complete risk evaluation for the relay protection system; and determining, according to a status of the leaf node in the target Bayesian network, a posterior probability of a status of the root node in the target Bayesian network by using the target Bayesian network to complete fault positioning for the relay protection system.

12. The apparatus of claim 9, wherein the processor is further configured to:
divide the plurality of fault events of the relay protection system into a top event, a bottom event and an intermediate event.

13. The apparatus of claim 12, wherein the processor is further configured to:
set an abnormality warning event occurring in the relay protection system to be the top event; set an abnormality warning event for decomposing a fault cause to an apparatus included in the relay protection system to be the intermediate event; and set an abnormality warning event for decomposing a fault cause of each apparatus into each apparatus to be the bottom event.

14. The apparatus of claim 12, wherein the processor is further configured to:
respectively transform the top event, the bottom event and the intermediate event of the fault tree into the leaf node, the root node and the intermediate node of the initial Bayesian network.

15. The apparatus of claim 9, wherein the plurality of statuses comprises severe abnormality, abnormality and normality.

16. The apparatus of claim 15, wherein logic of the Bayesian network conditional probability distribution table satisfies following formulas:
$$\begin{matrix} P ( N = {N}^{3} ) = \{ \begin{matrix}1 , if there is P ( M = {M}^{3} ) > 0 \\ 0 , if all P ( M = {M}^{3} ) = 0\end{matrix} ; \\ P ( N = {N}^{2} ) = \{ \begin{matrix}1 , if there is P ( M = {M}^{2} ) > 0 and P ( M ) = 0 \\ 0 , if there is no P ( M = {M}^{2} ) > 0 and P ( M = {M}^{3} ) = 0\end{matrix} ; \\ P ( N = {N}^{1} ) = 1 - P ( N = {N}^{2} ) - P ( N = {N}^{3} ) ;\end{matrix}$$
where P(N=Nⁱ) represents a probability that a node N is in a status i; P(M=Mⁱ) represents a probability that a father node M of the node N is in the status i, i=1, 2, 3; status 1 means normal, status 2 means abnormal, and status 3 means severely abnormal.

17. The apparatus of claim 15, wherein the processor is further configured to::
determine, by means of a following formula according to the prior probability that the root node in the target Bayesian network is in the different statuses, a probability that nodes taking the root node as a father node are in different statuses; repeatedly execute following steps until determining the probability that the leaf node in the target Bayesian network is in the different statuses: determine, by means of the following formula according to the probability that a target node is in different statuses, a probability that the nodes taking the target node as the father node are in different statuses, wherein the target node is a node that is determined last time and has a probability of different statuses;
$$P ( X = {X}^{i} ) \\ = \sum P ( {y}_{1} , … , {y}_{m} ; X = {X}^{i} ) \\ = {\sum }_{{k}_{1} , … , {k}_{m}} [ P ( X = {X}^{i} \vert {y}_{1} = {y}_{1}^{{k}_{1}} , … , {y}_{m} = {y}_{m}^{{k}_{m}} ) P ( {y}_{1} = {y}_{1}^{{k}_{1}} ) … P ( {y}_{m} = {y}_{m}^{{k}_{m}} ) ] ;$$
where P(X=Xⁱ) is a probability that a node X is in a status i; yⱼ is a farther node of the node X, j=1, 2, . . . , m; P(yⱼ=yⱼ^{k}^{ⱼ}); is a probability that a node yⱼ is in a status k_{f}; P(X=Xⁱ|yₗ=yₗ^{k}^{ₗ}, . . . , yₘ=yₘ^{k}^{ₘ}) is determined according to the Bayesian network conditional probability distribution table; i=1, 2, 3, kⱼ=1, 2, 3; state 1 means normal, status 2 means abnormal, and status 3 means severely abnormal; and k₁, . . . , kₘ is a status permutation and combination of y₁, . . . , yₘ.

18. The apparatus of claim 15, wherein the processor is further configured to::
under a known condition that a leaf node T is in a status i, calculate a posterior probability that a root node Zⱼ (j=1, . . . , n) in the target Bayesian network is in a status Sⱼ by using Bayesian formulas:
$$P ( {Z}_{j} = {Z}_{j}^{{s}_{j}} \vert T = {T}^{i} ) = \frac{P ( {Z}_{j} = {Z}_{j}^{{s}_{j}} , T = {T}^{i} )}{P ( T = {T}^{i} )} ;$$
where P(Zⱼ=Zⱼ^{s}^{ⱼ}|T=Tⁱ) is a probability that the root node Zⱼ is in the status sⱼ and the leaf node Tis in the status i, i=1, 2, 3, sⱼ=1, 2, 3; state 1 means normal, status 2 means abnormal, and status 3 means severely abnormal.

19. The non-transitory computer storage medium of claim 11, wherein the dividing the plurality of fault events of the relay protection system into the different hierarchy events comprises:
dividing the plurality of fault events of the relay protection system into a top event, a bottom event and an intermediate event.

20. The non-transitory computer storage medium of claim 19, wherein the dividing the plurality of fault events of the relay protection system into the top event, the bottom event and the intermediate event comprises:
setting an abnormality warning event occurring in the relay protection system to be the top event; setting an abnormality warning event for decomposing a fault cause to an apparatus included in the relay protection system to be the intermediate event; and setting an abnormality warning event for decomposing a fault cause of each apparatus into each apparatus to be the bottom event.

21. The non-transitory computer storage medium of claim 19, wherein the transforming the different hierarchy events in the fault tree into the different nodes of the initial Bayesian network comprises:
respectively transforming the top event, the bottom event and the intermediate event of the fault tree into the leaf node, the root node and the intermediate node of the initial Bayesian network.
